(19) United States
(12) Patent Application Publication
(10) Pub. No.: US 2005/0004787 A1
(43) Pub. Date: Jan. 6, 2005

(54) System and method for real time simulation

(76) Inventors: Marvin D. Kubischta, Prior Lake, MN (US); Robert J. Wellington, Bloomington, MN (US)

Correspondence Address: HOWREY SIMON ARNOLD & WHITE LLP, ATTEN: MARGARET P. DROSOS, DIRECTOR OF IP ADMIN, 2941 FAIRVIEW PARK DR, BOX 7, FALLS CHURCH, VA, 22042, US

(21) Appl. No.: 10/812,306

(22) Filed: Mar. 30, 2004

Related U.S. Application Data
(60) Provisional application No. 60/459,232, filed on Mar. 31, 2003.

(51) Int. Cl. G06F 7/60

(52) U.S. Cl. 703/19

(57) ABSTRACT

An embodiment of the invention generally relates to a method of real-time simulation. The method includes providing a continuous real-time clock to a non real-time simulator and synchronizing a simulation clock of the non real-time simulator with the continuous real-time clock on a continuous basis. The method also includes advancing the non real-time simulator to a first time based on the simulation clock reaching the first time.

### CROSS REFERENCE TO RELATED APPLICATIONS

This application claims priority to U.S. Provisional Application 60/459,232 filed on Mar. 31, 2003, which is incorporated in its entirety.

### BACKGROUND OF THE RELATED ART

A formidable challenge for laboratory integration and testing of a wireless distributed processing system is establishing a representative wireless network for data communication. Realistic network performance is particularly necessary when system operation is sensitive to the throughput, delay, and reliability characteristics of a low-bandwidth ad-hoc network.

When the processing node data interfaces are actually radios with embedded network protocols, the space, environmental, and logistical constraints of laboratory hardware-in-the-loop component testing requires emulating the performance of the wireless radio network. The unrealistic alternative to full-scale radio frequency network emulation in the laboratory is to take developmental equipment into the field and attempt to debug any functional or performance anomalies using the target radio network. Given the time and cost constraints, field-testing is not a preferred solution.

### SUMMARY OF THE INVENTION

An embodiment of the invention generally relates to a method of real-time simulation. The method includes providing a continuous real-time clock to a non real-time simulator and synchronizing a simulation clock of the non real-time simulator with the continuous real-time clock on a continuous basis. The method also includes advancing the non real-time simulator to a first time based on the simulation clock reaching the first time.

Another embodiment of the invention generally pertains to an apparatus for real-time simulation. The apparatus includes a non-real time simulator and a controller module configured to interface with the non real-time simulator and provide real-time simulation. The controller module is further configured to provide a continuous real time clock to the non real-time simulator to drive a simulation clock of the non real-time simulator and to advance the non real-time simulator to a first time on the simulation clock based on the continuous real time clock reaching the first time.

Yet another embodiment of the invention generally relates to a computer readable storage medium on which is embedded one or more computer programs. The one or more computer programs implement a method of real-time simulation. The one or more computer programs include a set of instructions for providing a continuous real-time clock to a non real-time simulator and synchronizing a simulation clock of the non real-time simulator with the continuous real-time clock on a continuous basis. The set of instructions also include advancing the non real-time simulator to a first time based on the simulation clock reaching the first time.

### BRIEF DESCRIPTION OF THE DRAWINGS

While the specification concludes with claims particularly pointing out and distinctly claiming the present invention, it may be believed the same will be better understood from the following description taken in conjunction with the accompanying drawings, which illustrate, in a non-limiting fashion, the best mode presently contemplated for carrying out the present invention, and in which like reference numerals designate like parts throughout the figures, wherein:

FIG. 1 illustrates a system 100 in accordance with an embodiment of the invention;

FIG. 2 illustrates a specific implementation of the system 100, shown in FIG. 1, as real-time wireless simulator system 200 in accordance with another embodiment of the embodiment;

FIG. 3 illustrates a more detailed block diagram of the controller module 110 shown in FIG. 1 in accordance with yet another embodiment of the invention;

FIG. 4 illustrates a flow diagram for the controller module 110 shown in FIG. 1 in accordance with yet another embodiment of the invention; and

FIG. 5 illustrates a computer system implementing the controller module 110 in accordance with yet another embodiment.

### DETAILED DESCRIPTION OF THE EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, many types of exchanged traded systems, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Embodiments generally relate to a controller module to convert a non-real time simulator for wireless networks into a real-time simulator for wireless networks. More particularly, the controller module may be adapted to interface with a conventional simulator, e.g., OPNET. The controller module may be further configured to operate the conventional simulator in real-time or near real-time. The controller module may provide a continuous real-time clock signal to the conventional simulator. The conventional simulator synchronizes its own clock to the continuous real-time clock signal on a continuous basis.

At each opportunity, e.g., T₄, the controller module may invoke the conventional simulator to forward the conventional simulation to the current time, e.g., T₄. When the controller module receives an event, the controller module may be configured to note the event time, T_{EVENT}. The controller module may then advance the conventional simulator up to the event time, T_{EVENT}. The controller module passes the event to the conventional simulator for simulation. The controller may then return to advancing the conventional simulator in real-time. In some embodiments, the controller module may instantiate a call-back function for each event passed to the conventional simulator. The call-back function provides a mechanism for the controller module to take the appropriate action when the passed event satisfies its pre-defined role in the simulation.

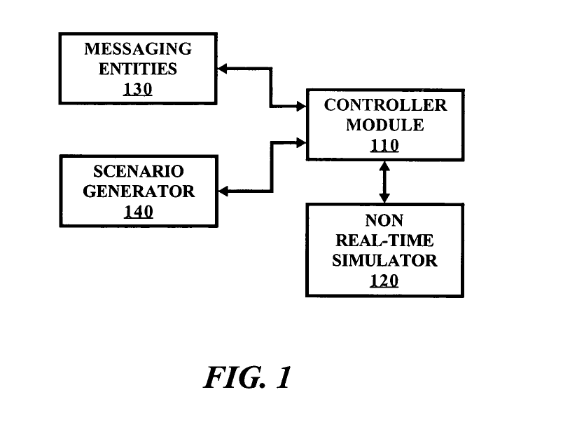

FIG. 1 illustrates a block diagram of a system 100 for real-time simulation in accordance with an embodiment of the invention. It should be readily apparent to those of ordinary skill in the art that the system 100 depicted in FIG. 1 represents a generalized schematic illustration and that other components may be added or existing components may be removed or modified. Moreover, the system improvement module 100 may be implemented using software components, hardware components, or a combination thereof.

As shown in FIG. 1, the system 100 includes a controller module 110, a non real-time simulator 120, message generating entities 130, and a scenario generator 140. The controller module 110 may be configured to drive the non real-time simulator 120 as a real-time simulator. More particularly, the controller module 110 may execute a control loop that advances the non real-time simulator in real-time or near real-time. The control loop utilizes the continuous real time clock associated with the underlying processor executing the system 100. The control module 110, on a continuous basis, advances the simulation executing in the non real-time simulator 120 to an equivalent time on a simulator clock associated with the non real-time simulator 120. For example, if the present time of real time clock of the control module 110 is at T₂, the control module 110 advances the simulator clock to T₂. When the time lag between the real-time clock and the simulator clock is small enough, the time lag has no discernable effect on the quality of simulation in the non real-time simulator 120.

The non real-time simulator 120 may be implemented as a conventional simulator. The non real-time simulator 120 may simulate a network, mechanical devices, or any device that may be simulated. In some embodiments, the non real-time simulator 120 may be implemented using OPNET™. OPNET is a software tool for performing network simulation and analysis that is available through OPNET Technologies, Inc. OPNET has the capability to model all types of networks including wireless networks as the behavior of queues, protocol stacks, and physical radio transmission/reception. Other embodiments may implement the non real-time simulator with ns2 or custom developed simulators.

The message generating entities 130 may be configured as message passing devices. For example, if system 100 is a simulation of a network where the non real-time simulator 120 is simulating a behavior of a wired network, the message generating entities 130 may be implemented as nodes, e.g., a bridge, a client, etc.

In certain embodiments, the message generating entities 130 may be emulating devices such as a radio. For example, a workstation may be configured to emulate the behavior of a radio for a wireless network simulation.

The scenario generator 140 may be configured to provide scenario information to the non real-time simulator 120 through the controller module. The scenario information may include configuration information, emulator client information, node positional information, etc.

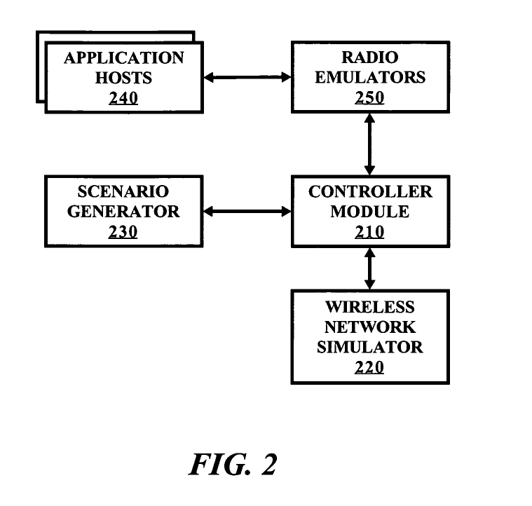

FIG. 2 illustrates a specific implementation of the system 100, shown in FIG. 1, as real-time wireless simulator system 200 in accordance with another embodiment of the embodiment. It should be readily apparent to those of ordinary skill in the art that the system 200 depicted in FIG. 2 represents a generalized schematic illustration and that other components may be added or existing components may be removed or modified. Moreover, the system improvement module 200 may be implemented using software components, hardware components, or a combination thereof.

As shown in FIG. 2, the system 200 includes a controller module 210, a wireless network simulator 220, a scenario generator 230, application hosts 240 and radio emulators 250. The controller module 210 configured to drive the wireless network simulator 220 as a real-time simulator. More particularly, the controller module 10 may execute a control loop that advances the wireless network simulator 220 in real-time or near real-time. In some embodiments, the control loop utilizes the continuous real time clock associated with the underlying processor executing the system 200. In other embodiments, an oscillation circuit may provide the real time clock signal. The control module 110, on a continuous basis, advances the simulation executing in the wireless network simulator 220 to an equivalent time on a simulator clock associated with the wireless network simulator 220 as the present time on the continuous real-time clock.

In this embodiment, the non-real time simulator is configured to emulate a wireless network, which may be implemented as the wireless network simulator 220. An example of a wireless network simulator 220 is OPNET™, as described previously.

The scenario generator 230 may be configured to provide simulation data for the wireless network simulator 220 via the controller module 210. For example, the simulation data may be geographic data, the number of nodes participating in the simulation, weather conditions, terrain features, or other similar types of information. More specifically, the scenario generator 230 may provide initial simulated radio node configurations and provide automatic mobile node positions.

The application hosts 240 may be configured to emulate communication nodes in a simulated network executed by the wireless network simulator 220. The application hosts 240 may generate messages for other application hosts through the radio emulators 250. More specifically, the application hosts 240 and radio emulators 250 exchange command, status, and message payloads to permit the radio emulators 250 to emulate radio transmission of the messages. The emulated radio messages are then forwarded to the controller module 110 for event processing in the wireless network simulator 220.

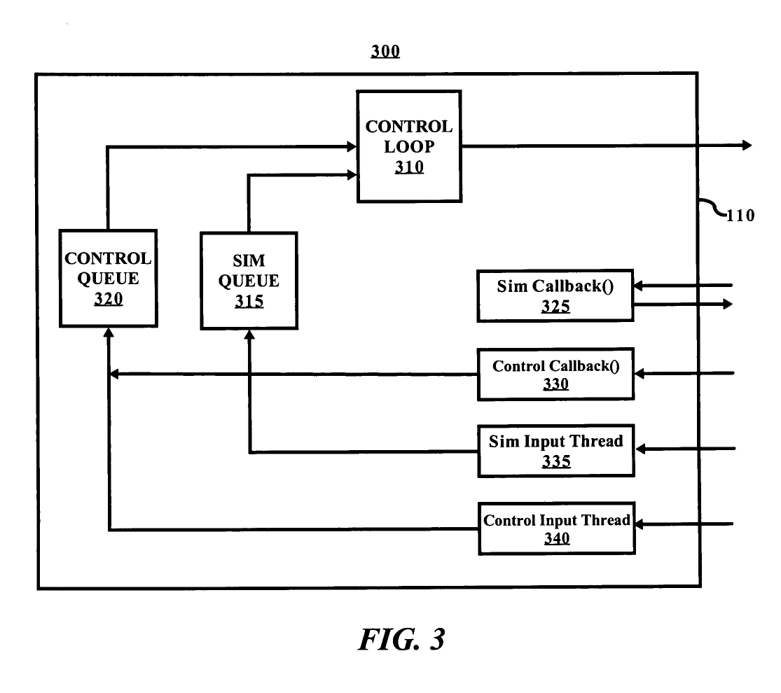

FIG. 3 illustrates a more detailed block diagram of the controller module 110 shown in FIG. 1 in accordance with yet another embodiment of the invention. It should be readily apparent to those of ordinary skill in the art that the diagram 300 depicted in FIG. 3 represents a generalized schematic illustration and that other components may be added or existing components may be removed or modified. Moreover, the controller module 110 may be implemented using software components, hardware components, or a combination thereof.

As shown in FIG. 3, the controller module 110 includes a control loop 310, a simulation queue 315 (labeled as sim queue), a control queue 320, a simulation callback 325, a control callback 330, a simulation input thread 335, and a control input thread 340.

The control loop 310 may be configured to provide the injection of messages into the non real-time simulator and advancing the simulation clock in discrete increments. The control loop 310 may also be configured to prioritize to messages on the control queue 320. For example, the control loop 310 may retrieve a message from the control queue 320 and provide the message to the non real-time simulator. In certain embodiments, the message may be node-positioning data for a scenario executing in the non real-time simulator.

The control loop 310 may be further configured to retrieve messages from the simulation queue 315, where the simulation messages have an associated time stamp. In one embodiment, the simulation queue 315 is configured to buffer messages that are passed between simulated network nodes of a scenario executing in the non real-time simulator. After retrieval from the simulation queue 315, the control loop may advance the simulation in the non real-time simulator to the time of the time stamp and forwards the simulation message to the non real-time simulator.

The simulation callback 325 and the control callback 330 may be callback functions registered with the non real-time simulator by the controller module 110. The simulation callback 325 is configured to receive notification of messages arriving at their intended simulated destination node within the non real-time simulator. Subsequently, the simulation callback 325 forwards the message to the external destination node. For example, in FIG. 2, an arriving messaging is forwarded to the radio emulator of the destination application host. The control callback 330 may be configured to receive notification of events associated with control messages.

The simulation input thread 335 may be configured to block on a read socket call waiting for the next incoming message from an external hardware in the loop or other message generating entity, e.g., messaging entities 130 in FIG. 1. These messages are strictly intended to pass between the simulated nodes within the non real-time simulator.

The control input thread 340 may be configured to process control messages, which are placed in the control queue 320. The control input thread 340 may be implemented using software constructs such as a daemon, a thread, etc.

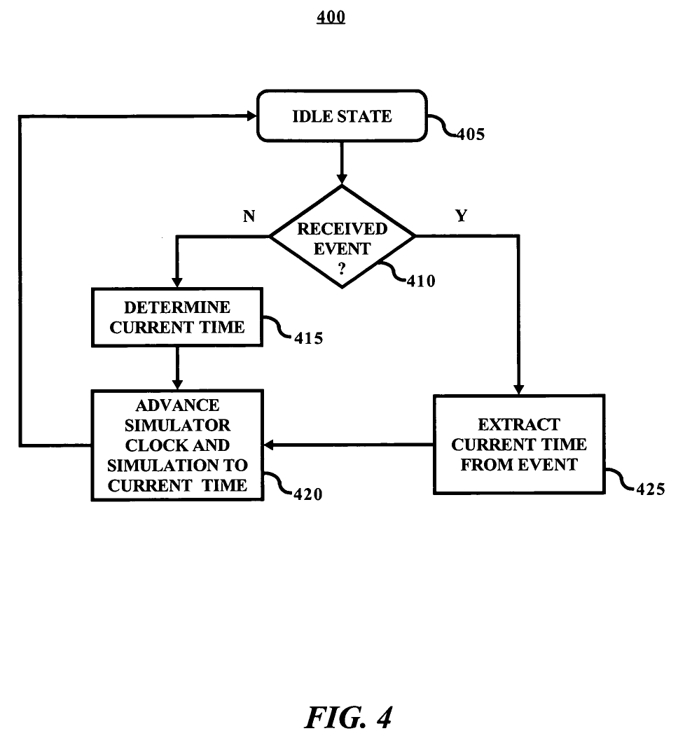

FIG. 4 illustrates a flow diagram 400 for the control loop 310 shown in FIG. 3 in accordance with yet another embodiment of the invention. It should be readily apparent to those of ordinary skill in the art that this flow diagram 400 represents a generalized illustration and that other steps may be added or existing steps may be removed or modified.

As shown in FIG. 4, the control loop 310 may be in an idle state 405. The control loop 310 may have been instantiated during the initialization. The control loop 310 may be configured to determine whether an event or message has been received, in step 410. More particularly, the control loop 310 may check the simulation queue 315 for new events arriving through the simulation input thread 335.

If the control loop 310 determines that an event has not arrived, the control loop 310 determines the current time, in step 415. The control loop 310 may execute a processor related command to retrieve the current time or an external clock may be provided in certain embodiments.

In step 420, the control loop 310 may execute or schedule a command for the non real-time simulator to advance the simulation to the present time and to advance the simulation clock to the current time. Subsequently, the control loop 310 returns to the idle state of step 405.

Returning to step 410, if the control loop determines that an event is pending in the simulation queue 315, the control loop 310 may extract a time from the event as the current time, in step 425. In certain embodiments, the event has an associated time stamp. Subsequently, the control loop 310 proceeds to the processing with step 420, as described previously.

Accordingly, the control loop 310 can advance a non real-time simulator in real-time by updating the simulation clock of the non real-time simulator.

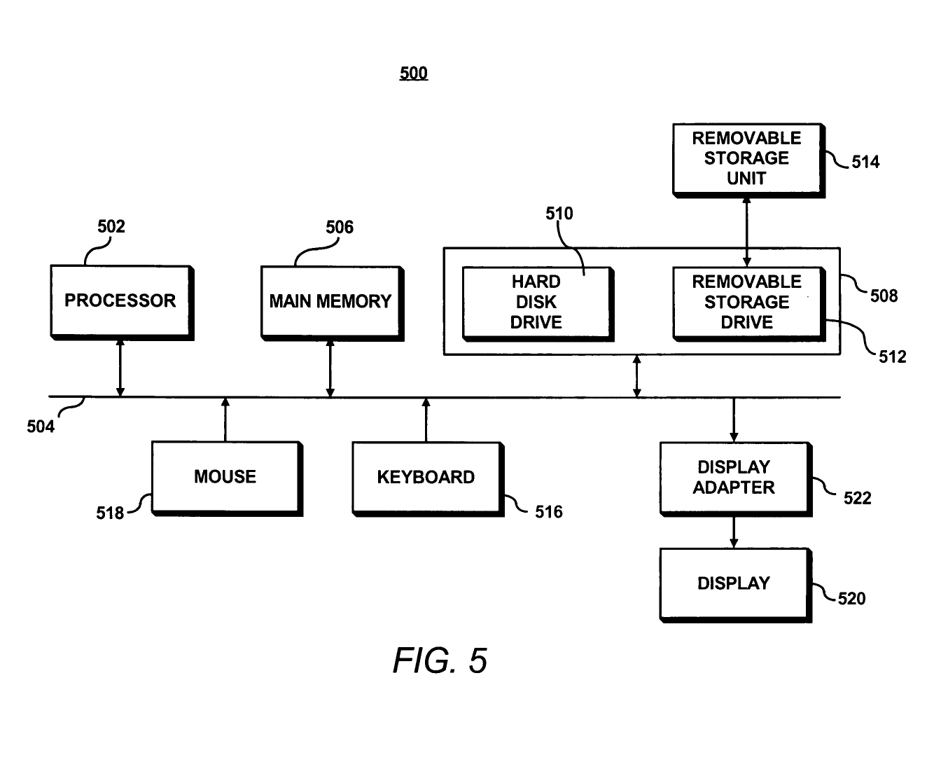

FIG. 5 illustrates a computer system implementing the controller module 110 in accordance with yet another embodiment of the invention. The functions of the validation module 100 may be implemented in program code and executed by the computer system 500. The validation module 100 may be implemented in computer languages such as PASCAL, C, C++, JAVA, etc.

As shown in FIG. 5, the computer system 500 includes one or more processors, such as processor 502, that provide an execution platform for embodiments of the controller module 110. Commands and data from the processor 502 are communicated over a communication bus 504. The computer system 500 also includes a main memory 506, such as a Random Access Memory (RAM), where the software for the controller module 110 may be executed during runtime, and a secondary memory 508. The secondary memory 508 includes, for example, a hard disk drive 510 and/or a removable storage drive 512, representing a floppy diskette drive, a magnetic tape drive, a compact disk drive, or other removable and recordable media, where a copy of a computer program embodiment for the controller module 110 may be stored. The removable storage drive 512 reads from and/or writes to a removable storage unit 514 in a well-known manner. A user interfaces with the controller module 110 with a keyboard 516, a mouse 518, and a display 520. The display adaptor 522 interfaces with the communication bus 504 and the display 520 and receives display data from the processor 502 and converts the display data into display commands for the display 520.

Certain embodiments may be performed as a computer program. The computer program may exist in a variety of forms both active and inactive. For example, the computer program can exist as software program(s) comprised of program instructions in source code, object code, executable code or other formats; firmware program(s); or other known program. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals arriving from the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

1. A method of real-time simulation, the method comprising:
providing a continuous real-time clock to a non real-time simulator;
synchronizing a simulation clock of the non real-time simulator with the continuous real-time clock on a continuous basis; and
advancing the non real-time simulator to a first time based on the simulation clock reaching the first time.

2. The method according to claim 1, further comprising:
advancing the non real-time simulator to a second time based on the simulation clock reaching the second time.

3. The method according to claim 1, further comprising:
receiving an event for the non real-time simulator at a second time on the continuous real time clock; and
advancing the non real-time simulator to a time on the simulation clock equivalent to the second time on the continuous real time clock.

4. The method according to claim 3, further comprising:
submitting the event to the non real-time simulator for simulation at the time on the simulation clock.

5. The method according to claim 4, further comprising:
instantiating a call-back function for the event.

6. The method according to claim 5, further comprising:
initiating the call-back function in response to the event satisfying a predefined role in the non real-time simulator.

7. An apparatus for real-time simulation, the apparatus comprising:
a non-real time simulator; and
a controller module configured to interface with the non real-time simulator and provide real-time simulation, wherein the controller module is further configured to provide a continuous real time clock to the non real-time simulator to drive a simulation clock of the non real-time simulator and to advance the non real-time simulator to a first time on the simulation clock based on the continuous real time clock reaching the first time.

8. The apparatus according to claim 7, wherein the controller module is further configured to advance the non real-time simulator to a second time on the simulation clock based on the continuous real time clock reaching the second time.

9. The apparatus according to claim 7, wherein the controller module is further configured to receive an event for the non real-time simulator at an event time on the continuous real-time clock.

10. The apparatus according to claim 9, wherein the controller module is further configured to map the event time to a simulation event time and to advance the non real-time simulator to the simulation event time.

11. The apparatus according to claim 10, wherein the controller module is further configured to forward the event to the non real-time simulator.

12. The apparatus according to claim 7, further comprising:
a configuration entity configured to provide configuration to the controller module.

13. The apparatus according to claim 12, wherein the configuration entity is a scenario generator.

14. The apparatus according to claim 7, further comprising:
a messaging entity configured to provide messages for simulation to the controller module.

15. The apparatus according to claim 14, wherein the messaging entity is a radio emulator.

16. The apparatus according to claim 7, wherein the controller module further comprises:
a real-time controller loop configured to the non real-time simulator;
a traffic output module adapted to accept output messages from the non-real-time simulator;
a traffic input module adapted to receive input messages from a messaging entity; and
a packet queue configured to buffer input and output messages.

17. A computer readable storage medium on which is embedded one or more computer programs, the one or more computer programs implementing a method of real-time simulation, the one or more computer programs comprising a set of instructions for:
providing a continuous real-time clock to a non real-time simulator;
synchronizing a simulation clock of the non real-time simulator with the continuous real-time clock on a continuous basis; and
advancing the non real-time simulator to a first time based on the simulation clock reaching the first time.

18. The set of instructions according to claim 17, further comprising:
advancing the non real-time simulator to a second time based on the simulation clock reaching the second time.

19. The set of instructions according to claim 17, further comprising:
receiving an event for the non real-time simulator at a second time on the continuous real time clock; and
advancing the non real-time simulator to a time on the simulation clock equivalent to the second time on the continuous real time clock.

20. The set of instructions according to claim 19, further comprising:
submitting the event to the non real-time simulator for simulation at the time on the simulation clock.

21. The set of instructions according to claim 20, further comprising:
instantiating a call-back function for the event.

22. The set of instructions according to claim 21, further comprising:
initiating the call-back function in response to the event satisfying a predefined role in the non real-time simulator.
